(19) United States
(12) Patent Application Publication
(10) Pub. No.: US 2026/0143447 A1
(43) Pub. Date: May 21, 2026

(54) ENHANCED SOLUTION SEPARATION RECEIVER AUTONOMOUS INTEGRITY MONITORING FOR POSITIONING ENGINE

(71) Applicant: QUALCOMM Incorporated, San Diego, CA (US)

(72) Inventors: Min WANG, Tustin, CA (US); Kevin SHI, San Marino, CA (US)

(21) Appl. No.: 18/952,947

(22) Filed: Nov. 19, 2024

(51) Int. Cl. H04W 64/00; H04W 24/08; H04W 24/10

(52) U.S. Cl. CPC H04W 64/00; H04W 24/08; H04W 24/10

(57) ABSTRACT

Aspects presented herein may enable a UE to eliminate low accuracy “subset positions” and/or “all-in-view position” from a solution separation (SS) receiver autonomous integrity monitoring (RAIM) (SS RAIM) evaluation, thereby improving the computation efficiency for the SS RAIM. In one aspect, a UE estimates a plurality of positions of the UE using all space vehicles (SVs) in a list of SVs and a plurality of subsets of SVs in the list of SVs. The UE excludes a set of positions in the plurality of positions from an SS evaluation if at least one of: (1) a weighted sum of squared residual (WSS) of the set of positions is greater than a chi-square threshold, or (2) a computed residual of the set of positions indicates a negative value. The UE performs the SS evaluation based on rest of the plurality of positions.

### TECHNICAL FIELD

The present disclosure relates generally to communication systems, and more particularly, to wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (cMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some telecommunication standards also provide positioning protocols and techniques that enable mobile network operators to provide high-accuracy location services to their subscribers. For example, 5G NR include various standards for network-based positioning that use signals and features of the 5G network to perform or improve the positioning of a device. There also exists a need for further improvements in these positioning protocols and techniques.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus estimates a plurality of positions of a user equipment (UE) using all space vehicles (SVs) in a list of SVs and a plurality of subsets of SVs in the list of SVs. The apparatus excludes a set of positions in the plurality of positions from a solution separation (SS) evaluation if at least one of: (1) a weighted sum of squared residual (WSS) of the set of positions is greater than a chi-square threshold or (2) a computed residual of the set of positions indicates a negative value. The apparatus performs, after excluding the set of positions in the plurality of positions, the SS evaluation based on rest of the plurality of positions.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of global navigation satellite system (GNSS) positioning in accordance with various aspects of the present disclosure.

FIG. 6 is a diagram illustrating an example navigational frequency band for GNSS, globalnaya navigatsionnaya sputnikovaya sistema (GLONASS), and Galileo in accordance with various aspects of the present disclosure.

FIG. 7 is a diagram illustrating an example solution separation (SS) receiver autonomous integrity monitoring (RAIM) (SS RAIM) algorithm in accordance with various aspects of the present disclosure.

FIG. 8 is a diagram illustrating an example SS RAIM implementation in accordance with various aspects of the present disclosure.

FIG. 9 is a diagram illustrating an example of an all-in-view position and a plurality of subset positions for FaultMode-0 in accordance with various aspects of the present disclosure.

FIG. 10 is a diagram illustrating an example of an all-in-view position and a plurality of subset positions for FaultMode-1 in accordance with various aspects of the present disclosure.

FIG. 11 is a diagram illustrating an example SS RAIM implementation with a position validator capable of validating outlier(s) in all-in-view position and subset positions in accordance with various aspects of the present disclosure.

FIG. 12A is a diagram illustrating an example residual truth for SVs in accordance with various aspects of the present disclosure.

FIG. 12B is a diagram illustrating an example multi-path (MP) residual for SVs in accordance with various aspects of the present disclosure.

FIG. 12C is a diagram 1200C illustrating an example MP residual for SVs in accordance with various aspects of the present disclosure.

FIG. 13 is a flowchart of a method of location estimation.

FIG. 14 is a flowchart of a method of location estimation.

FIG. 15 is a diagram illustrating an example of a hardware implementation for an example apparatus and/or network entity.

### DETAILED DESCRIPTION

Aspects presented herein may improve the overall performance of solution separation (SS) receiver autonomous integrity monitoring (RAIM) (SS RAIM) (or the overall performance of a positioning engine configured to perform SS RAIM) by enabling the “all-in-view position” and the “subsets positions” calculated by the SS RAIM to be validated (e.g., by a position validator module) to eliminate certain low accuracy “subset positions” and/or “all-in-view position” from an SS evaluation. For example, in one aspect, a position validator module may be configured to check whether there is any outlier(s) in the “all-in-view position” and the “subsets positions” based on whether their WSS follows a chi-square (Chi2) distribution, and also use a residual multi-path (MP) sign check to detect the outlier(s). As such, aspects presented herein may enable early exit for some fault modes of the SS RAIM, and also improve the computation efficiency for the SS RAIM. For example, based on validating the “all-in-view position” and the “subsets positions,” the SS RAIM may permit just high accuracy “subset positions” to participate the SS evaluation, thereby enabling a list of SVs to have a higher chance of passing the SS evaluation. Aspects presented herein may also enable the SS RAIM to have a less chance of selecting a wrong or improper SV to be excluded in a subsequent SS test.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

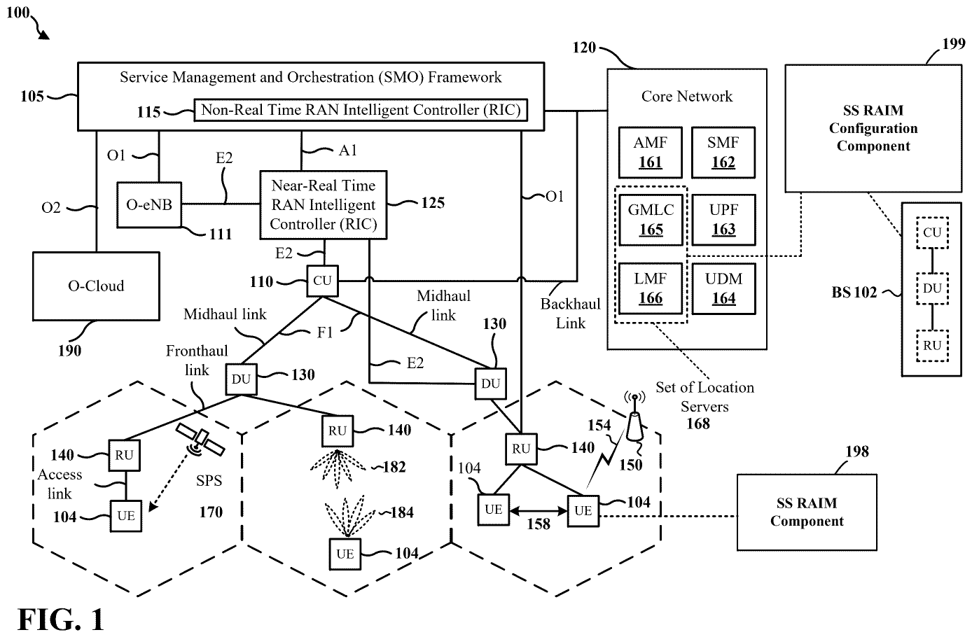

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO

Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FRI (410 MHZ-7.125 GHZ) and FR2 (24.25 GHz-52.6 GHZ). Although a portion of FR1 is greater than 6 GHz, FRI is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an SS RAIM component 198 that may be configured to estimate a plurality of positions of the UE using all space vehicles (SVs) in a list of SVs and a plurality of subsets of SVs in the list of SVs; exclude a set of positions in the plurality of positions from a solution separation (SS) evaluation if at least one of: (1) a weighted sum of squared residual (WSS) of the set of positions is greater than a chi-square threshold or (2) a computed residual of the set of positions indicates a negative value; and perform, after excluding the set of positions in the plurality of positions, the SS evaluation based on rest of the plurality of positions. In certain aspects, the base station 102 or the one or more location servers 168 may have an SS RAIM configuration component 199 that may be configured to provide configurations and/or parameters related to SS RAIM for the UE 104.

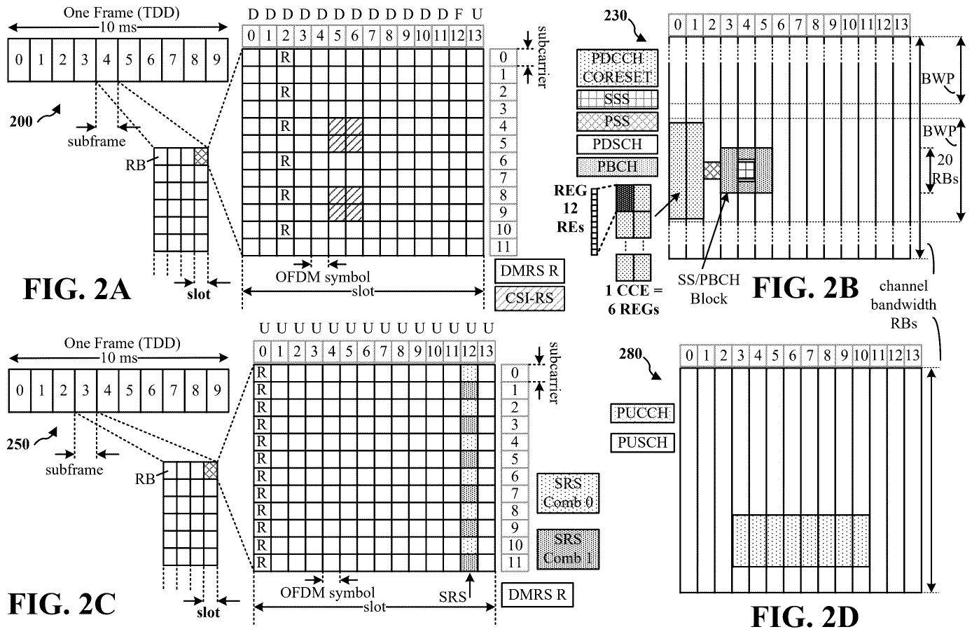

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{∥} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

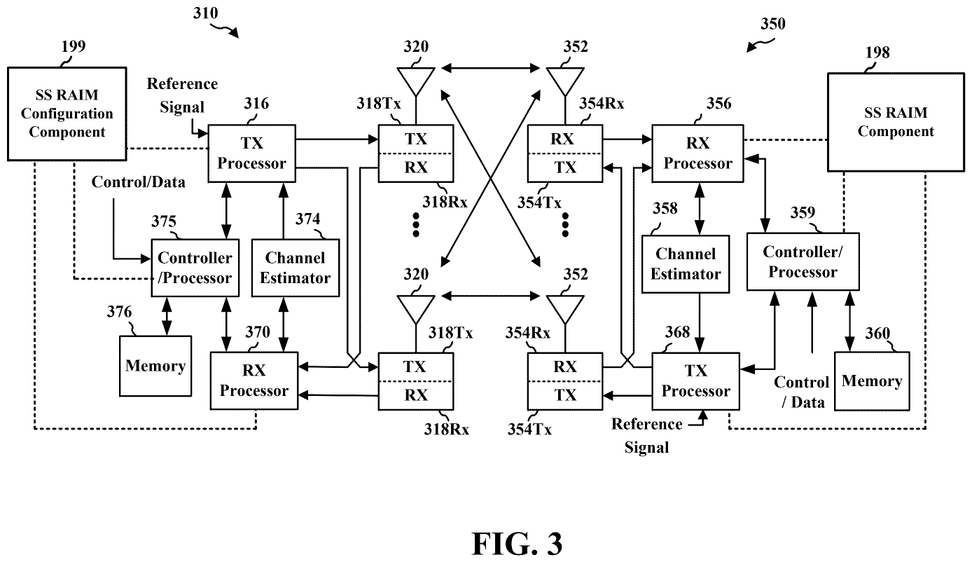

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the SS RAIM component 198 of FIG. 1.

At least one of the TX processor 316, the RX processor 370, and the controller/processor 375 may be configured to perform aspects in connection with the SS RAIM configuration component 199 of FIG. 1.

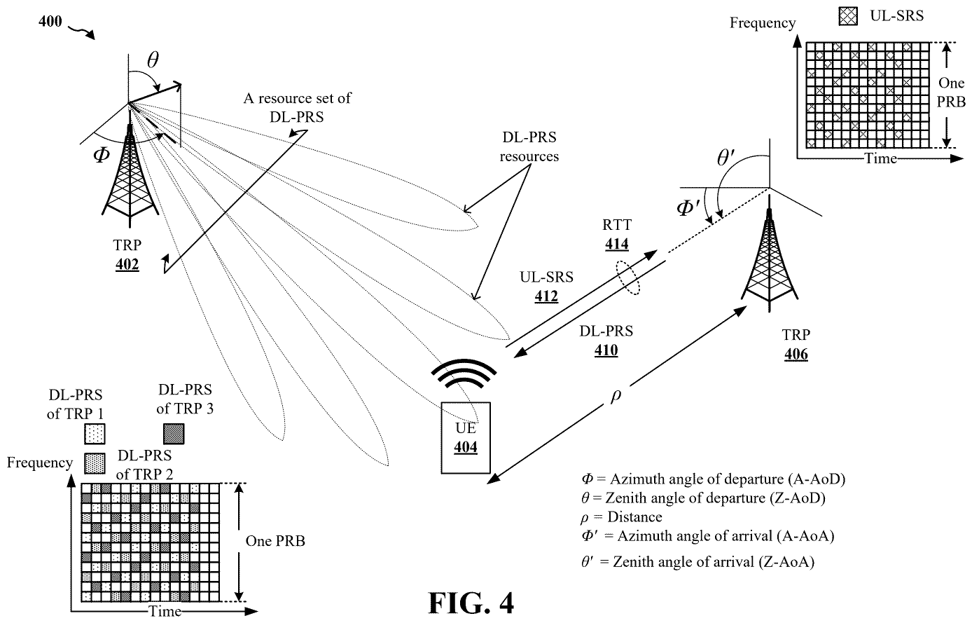

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}-T_{PRS_TX}|-T_{SRS_TX}-T_{PRS_RX}∥. Accordingly, multi-RTT positioning may make use of the UE Rx-Tx time difference measurements (i.e., |T_{SRS_TX}-T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}-T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FRI, the reference point for the DL PRS-RSRP may be the antenna connector of the UE. For FR2, DL PRS-RSRP may be measured based on the combined signal from antenna elements corresponding to a given receiver branch. For FRI and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

A device (e.g., a UE) equipped with a global navigation satellite system (GNSS) receiver may determine its location based on reception of signals from multiple satellites, which may be referred to as “GNSS positioning,” “GNSS-based positioning” or “satellite-based positioning,” etc. GNSS includes a network of satellites broadcasting timing and orbital information used for navigation and positioning measurements. In addition, GNSS may refer to the International Multi-Constellation Satellite System, which may include global positioning system (GPS), global navigation satellite system (GLONASS), BeiDou Navigation Satellite System (BDS), Galileo, and any other constellation system. GNSS may include multiple groups of satellites (which may be referred to as GNSS satellites), known as constellations, that broadcast signals (which may be referred to as GNSS signals) to control stations and users of the GNSS. Based on the broadcast signals, the users may be able to determine their locations (e.g., via a trilateration process). For purposes of the present disclosure, a device (e.g., a UE) that is equipped with a GNSS receiver or is capable of receiving GNSS signals may be referred to as a GNSS device, and a device that is capable of transmitting GNSS signals, such as a satellite, may be referred to as a space vehicle (SV).

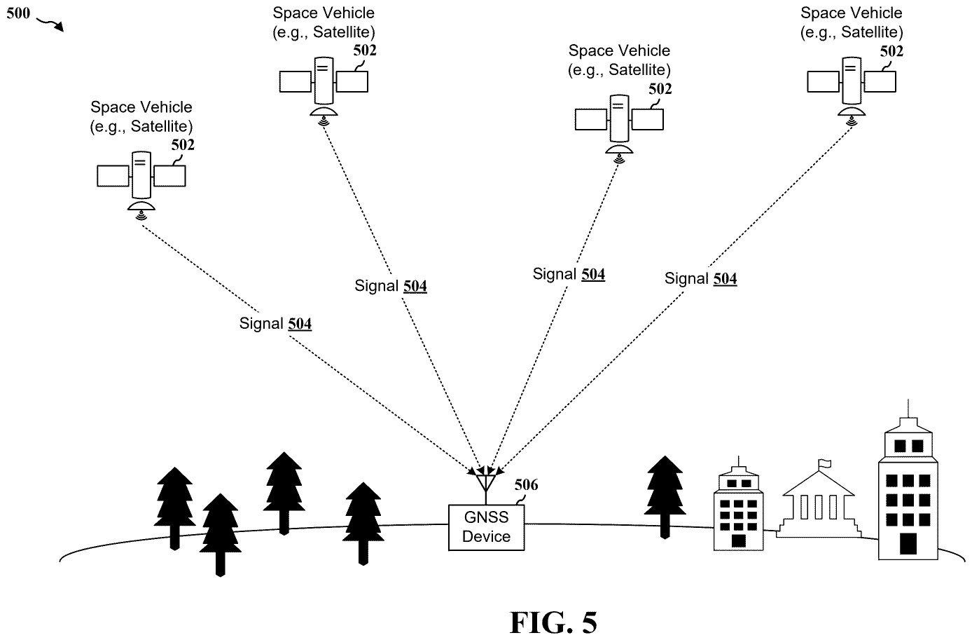

FIG. 5 is a diagram 500 illustrating an example of GNSS positioning in accordance with various aspects of the present disclosure. A GNSS device 506 may calculate its position and time based at least in part on data (e.g., GNSS signals 504) received from SVs 502, where each SV 502 may carry a record of its position and time and may transmit that data (e.g., the record) to the GNSS device 506. Each SV 502 may further include a clock that is synchronized with other clocks of SVs and with ground clock(s). If an SV 502 detects that there is a drift from the time maintained on the ground, the SV 502 may correct it. The GNSS device 506 may also include a clock, but the clock for the GNSS device 506 may be less stable and precise compared to the clocks for each SV 502.

As the speed of radio waves may be constant and independent of the satellite speed, a time delay between a time the SV 502 transmits a GNSS signal 504 and a time the GNSS device 506 receives the GNSS signal 504 may be proportional to the distance from the SV 502 to the GNSS device 506. In some examples, a minimum of four SVs may be used by the GNSS device 506 to compute/calculate one or more unknown quantities associated with positioning (e.g., three position coordinates and clock deviation from satellite time, etc.).

Each SV 502 may broadcast the GNSS signal 504 (e.g., a carrier wave with modulation) continuously that may include a pseudorandom code (e.g., a sequence of ones and zeros) which may be known to the GNSS device 506, and may also include a message that includes a time of transmission and the SV position at that time. In other words, each GNSS signal 504 may carry two types of information: time and carrier wave (e.g., a modulated waveform with an input signal to be electromagnetically transmitted). Based on the GNSS signals 504 received from each SV 502, the GNSS device 506 may measure the time of arrivals (ToAs) of the GNSS signals 504 and calculate the time of flights (ToFs) for the GNSS signals 504. Then, based on the ToFs, the GNSS device 506 may compute its three-dimensional position and clock deviation, and the GNSS device 506 may determine its position on the Earth. For example, the GNSS device 506's location may be converted to a latitude, a longitude, and a height relative to an ellipsoidal Earth model. These coordinates may be displayed, such as on a moving map display, or recorded or used by some other system, such as a vehicle guidance system.

While the distance between a GNSS device and an SV may be calculated based on the time it takes for a GNSS signal to reach the GNSS device, the SV's signal sequence may be delayed in relation to the GNSS device's sequence. Thus, in some examples, a delay may be applied to the GNSS device's sequence, such that the two sequences are aligned. For example, to calculate the delay, a GNSS device may align a pseudorandom binary sequence contained in the SV's signal to an internally generated pseudorandom binary sequence. As the SV's GNSS signal takes time to reach the GNSS device, the SV's sequence may be delayed in relation to the GNSS device's sequence. By increasingly delaying the GNSS device's sequence, the two sequences may eventually be aligned.

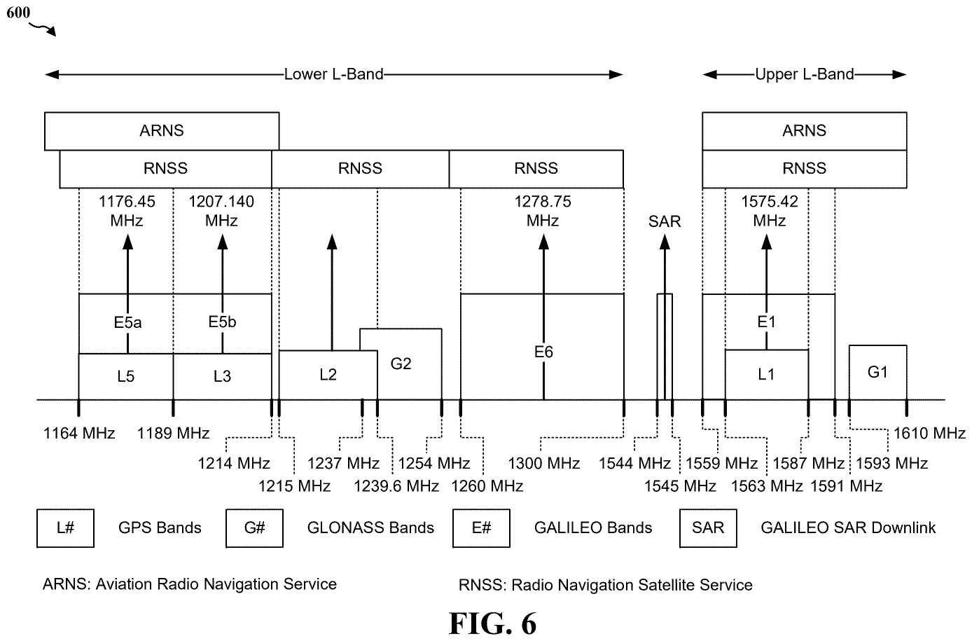

FIG. 6 is a diagram 600 illustrating an example navigational frequency band for GNSS (e.g., global positioning system (GPS), globalnaya navigatsionnaya sputnikovaya sistema (GLONASS), and Galileo, which may also be referred to as Radio Navigation Satellite System (RNSS)) in accordance with various aspects of the present disclosure. There may be two bands in the region allocated to the Aeronautical Radio Navigation Service (ARNS) on a primary basis worldwide, where these bands may be suitable for Safety-of-Life applications as other users may not be allowed to interfere with their signals. They may correspond to an upper L-band (e.g., 1559-1610 MHZ), having the GPS L1, Galileo E1 and GLONASS G1, and to the bottom of a lower L-band (e.g., 1151-1214 MHZ) where GPS L5 and Galileo E5 are located, with E5a and L5 coexisting in the same frequencies. The remaining GPS L2, GLONASS G2 and Galileo E6 signals are in the bands 1215.6-1350 MHz. These bands may be allocated to radio-location services (e.g., ground radars) and RNSS on a primary basis, hence the signals in these bands may be more vulnerable to interference compared to the previous ones.

In some examples, a software or an application that accepts positioning related measurements from global navigation satellite system (GNSS)/global positioning system (GPS) chipsets and/or sensors to estimate position, velocity, and/or altitude of a device may be referred to as a positioning engine (PE). In addition, a positioning engine that is capable of achieving certain high level of accuracy (e.g., centimeter/decimeter level accuracy) and/or latency may be referred to as a precise positioning engine (PPE). For example, a positioning engine that is capable of performing real-time kinematic (RTK) (e.g., receiving or processing correction data associated with RTK) may be considered as a PPE. Another example of PPE is a positioning engine that is capable of performing precise point positioning (PPP). PPP is a positioning technique that removes or models GNSS system errors to provide a high level of position accuracy from a single receiver. For purposes of the present disclosure, a “solution,” such as a PE solution, a PPE solution, and/or a PPP solution, may refer to a set of outputs from a positioning engine module. For example, a PE solution may include a set of parameters associated with a Kalman Filter (KF) or a KF state, where the set of parameters may include position, velocity, timing, uncertainty, outlier information, integrity information, receiver clock, receiver clock rate, inter-satellite-type bias, and/or ambiguity terms, etc. In some examples, a solution may depend on GNSS satellite clock and orbit corrections, generated from a network of global reference station. Once the corrections are calculated, they may be delivered to the end user via satellite or over the Internet. These corrections may then be used by the receiver, which may result in decimeter-level or better positioning with no base station involved.

GNSS-based positioning may be subjected to various errors that may affect the accuracy of the positioning, and these errors may come from different sources and may impact the precision of the positioning data. For example, errors associated with GNSS-based positioning may include: (1) an ionospheric delay (e.g., delays caused by the ionosphere as a signal passes through), (2) a tropospheric delay (e.g., delays caused by the troposphere as a signal passes through due to humidity and atmospheric pressure variations, (3) clock errors (e.g., satellite clocks may not be perfect and their accuracy may introduce errors), (4) ephemeris errors (e.g., the ephemeris data, which provides information about the satellite's position over time, may not always be accurate), (5) multipath interference (e.g., signals may reflect off nearby surfaces, such as buildings or water, before reaching the receiver), (6) receiver noise (e.g., GNSS receivers may introduce noise or errors in the measurement process), and/or (7) satellite geometry (e.g., the arrangement of satellites in the sky relative to the receiver may affect the accuracy of the positioning), etc.

Receiver autonomous integrity monitoring (RAIM) is a technique that may be used in GNSS-based positioning for assessing the integrity of the signals received from satellites and ensuring the accuracy and reliability of the navigation solution. For example, GNSS systems, such as the GPS, may provide positioning, navigation, and timing information by triangulating signals from multiple satellites, and RAIM may be employed to detect and mitigate errors (e.g., which may include satellite errors discussed above) in these signals. In other words, the primary purpose of RAIM is to identify and exclude faulty satellite signals from the navigation solution, which may also be referred to as a GNSS outlier detection. For purposes of the present disclosure and in the context of GNSS positioning, an outlier may refer to a measurement or data point that deviates significantly from the expected or typical values. These deviations may cause errors in the position solution because outliers may be caused by various factors that affect the accuracy of GNSS signals, such as: (1) multi-path (MP) effects (e.g., when GNSS signals reflect off surfaces like buildings or the ground, they can create delays and alter the travel time of the GNSS signals, leading to incorrect positioning data), (2) atmospheric errors (e.g., variations in the ionosphere and troposphere may affect the speed of GNSS signals, introducing errors), (3) signal blockages (e.g., buildings, trees, or other obstructions may block or distort signals, leading to inaccurate measurements), (4) receiver noise (e.g., the quality of the GNSS receiver may introduce random errors or noise that may manifest as outliers), and/or (5) faulty satellites (e.g., occasionally, malfunctioning satellites may broadcast erroneous information that may result in positioning errors). As outliers may distort the overall accuracy of the computed position, to mitigate their impact, various filtering and statistical methods (like RAIM) are used to identify and exclude these outliers from the positioning solution.

There may be different types of RAIM algorithms for GNSS outlier detection. For example, one type of RAIM is residual-based (RB) RAIM (RB RAIM), which uses all available measurements to identify the possible GNSS outlier based on residual analysis (e.g., based on a global check and a local check). In a traditional RAIM, the integrity of a navigation solution is assessed by comparing the measured pseudo-range or pseudo-range rate (distance measurements) from multiple satellites with the expected values based on the known positions of those satellites. Residuals are the differences between the measured and expected values. If the residuals exceed a predefined threshold, it may indicate a potential issue with the signal integrity, and the faulty satellite measurements may be excluded from the navigation solution. An RB RAIM may take the concept of residuals a step further by considering not just the individual satellite measurements but also the relationships between them. For example, instead of just looking at the residuals independently for each satellite, an RB RAIM may consider the inter-satellite measurements, and exploit the redundant information available from multiple satellites. By analyzing the relationships between satellites, the RB RAIM may detect and mitigate certain types of faults that may not be apparent in traditional RAIM. However, under the RB RAIM, there may be an assumption that the residuals are Gaussian (e.g., are based on a Gaussian distribution). Thus, when a significant amount of measurements has outliers (e.g., due to multipath), the RB RAIM may not work accurately (e.g., when 15 out of 30 measurements have outliers).

Another type of RAIM is the solution separation (SS) RAIM (SS RAIM), which uses subsets of available measurements, and the strategy of how to use the subsets of available measurements may vary (e.g., just L5 subset, just above CNO threshold subset, etc.). An SS RAIM may enable residual analysis to be conducted within each subset, and each subset may provide a position estimate. Under the SS RAIM, each subset may specify a redundancy (e.g., the number of measurements is greater than the number of unknown estimates). Then, the SS RAIM may identify possible GNSS outliers based on comparison of position estimates of all subsets. For example, the SS RAIM may compare multiple independent position solutions generated by a GNSS receiver. These position solutions may be calculated using different combinations of available satellites and their measurements. By comparing these solutions, the GNSS receiver may detect any inconsistencies or errors in the measurements. If there is a problem with the measurements or if some of the satellite signals are unreliable, the position solutions may diverge significantly, and this divergence may be an indication that the integrity of the navigation solution might be compromised.

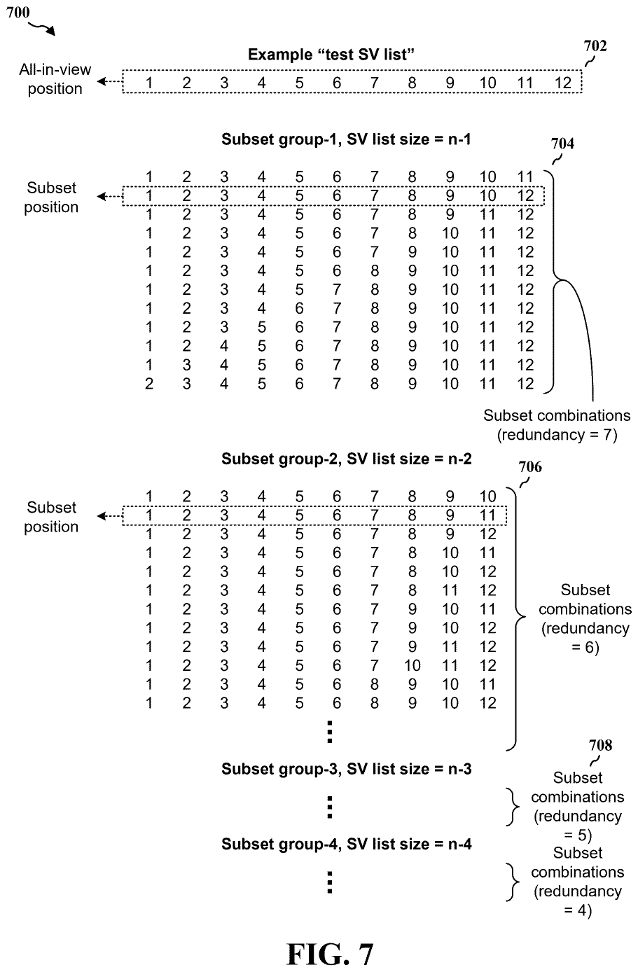

FIG. 7 is a diagram 700 illustrating an example SS RAIM algorithm in accordance with various aspects of the present disclosure. The SS RAIM may rely on SS test for outlier detection of a selected “test SV list.” As an illustration, assuming there are twelve SVs (e.g., SV 1 to SV 12) in a test SV list, an SS test may include generating an “all-in-view” position and multiple “subset positions” based on the SVs in this “test SV list.” For example, as shown at 702, an “all-in-view” position for a GNSS device (e.g., a UE, GNSS receiver, etc.) may be determined using all twelves SVs in the test SV list. Then, as shown at 704, 706, and 708, the SS test may generate all possible “subset positions” from all possible combinations of SVs in the test SV list.

For example, as shown at 704, a set of subset positions may be generated using different combinations of eleven SVs selected from the test SV list, which may include a first subset position determined using SVs 1, 2, 3, 4, 5, 6, 7, 8, 9, 10, and 11, a second subset position determined using SVs 1, 2, 3, 4, 5, 6, 7, 8, 9, 10, and 12, a third subset position determined using SVs 1, 2, 3, 4, 5, 6, 7, 8, 9, 11, and 12, . . . , etc. Also, in the context of GNSS positioning, “redundancy” may refer to “the number of measurements” minus “the number of unknown states to be estimated.” For example, “the number of measurements” for the subset group-1 described herein is eleven (11). Typically for GNSS position/clock estimation, the “the number of unknown state to be estimated” is four (4). Therefore, the “redundancy” for the subset group-1 may be seven (7). Similarly, as shown at 706, another set of subset positions may be generated using different combinations of ten SVs selected from the test SV list, which may include a first subset position determined using SVs 1, 2, 3, 4, 5, 6, 7, 8, 9, and 10, a second subset position determined using SVs 1, 2, 3, 4, 5, 6, 7, 8, 9, and 11, a third subset position determined using SVs 1, 2, 3, 4, 5, 6, 7, 8, 9, and 12, . . . , etc.

As discussed above, each subset may specify at least a defined number of redundancy (e.g., the number of measurements may be specified to be greater than the number of unknown estimates (# of measurement > # of unknown estimate), and each subset may provide a position estimate of the GNSS device. As such, for purposes of the present disclosure and also for differentiation/illustrative purposes, a position of a GNSS device/UE that is determined using all SVs in a list of SVs may be referred to as an “all-in-view position” or “all-in-view solution” (e.g., as shown at 702) and a position of the GNSS device/UE that is determined using a subset of SVs in the list of SVs may be referred to as a “subset position” or a “subset solution” (e.g., as shown at 704 and 706).

After the SS test generates the all-in-view position and the plurality of subset positions based on the test SV list, the SS test (or the GNSS device) may detect whether there arc outlier(s) in “test SV list” based on the comparison of the “all-in-view position” with all “subset positions.” For example, the all-in-view position may be compared with each subset position determined using different combinations of eleven SVs shown at 704, and also compared with each subset position determined using different combinations of ten SVs shown at 706, and so on. If the comparison between the all-in-view position and a subset position shows a difference that is greater than a defined threshold (difference >threshold), it may indicate that the SS test fails and there may be one or more outliers in the test SV list. On the other hand, if the comparisons between the all-in-view position and all subset positions do not show a difference that is greater than the defined threshold, the SS test is considered pass/success, and the all-in-view position may be output/determined to be a valid position.

If the SS test fails (e.g., the comparison between the all-in-view position and a subset position shows a difference that is greater than the defined threshold), the GNSS device may be configured to remove one SV from the test SV list to shrink the test SV list (assuming SV 1 is removed from the test SV list so that the test SV list now has just 11 SVs). Then, the GNSS device may determine a (new) all-in-view position using the (new) test SV list (e.g., determine the all-in-view position using SV 2 to SV 12), and then compare the (new) all-in-view position with all subset positions determined based on all possible combinations of subsets of SVs in the (new) test SV list, such as discussed in connection with 702, 704, and 706. The GNSS may be configured to perform the iteration to shrink the “test SV list” until the SS test passes (e.g., iteration of “fault mode assumptions” which will be discussed with examples below).

As it may be observed, the SS RAIM may demand higher computational power/cost compared to the RB RAIM, but SS RAIM typically provide better performance than the RB RAIM when measurements include a significant amount of outliers. As such, example applications of the SS RAIM may include improving GNSS positioning accuracy in a challenging environment (e.g., multiple outliers due to multi-path (MP)), and/or improving the integrity protection level for automotive platform and provide lower integrity risk bound, etc.

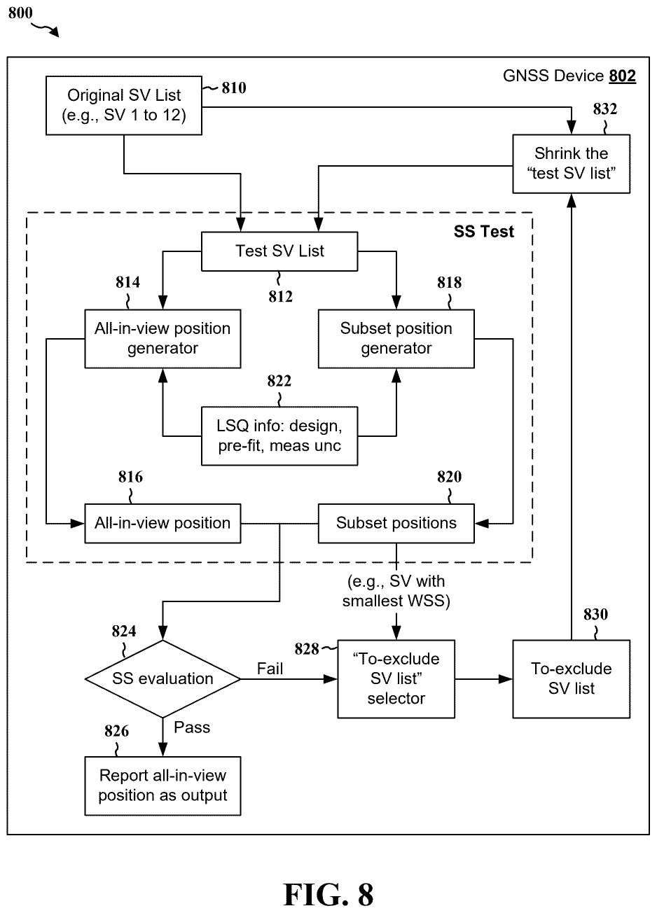

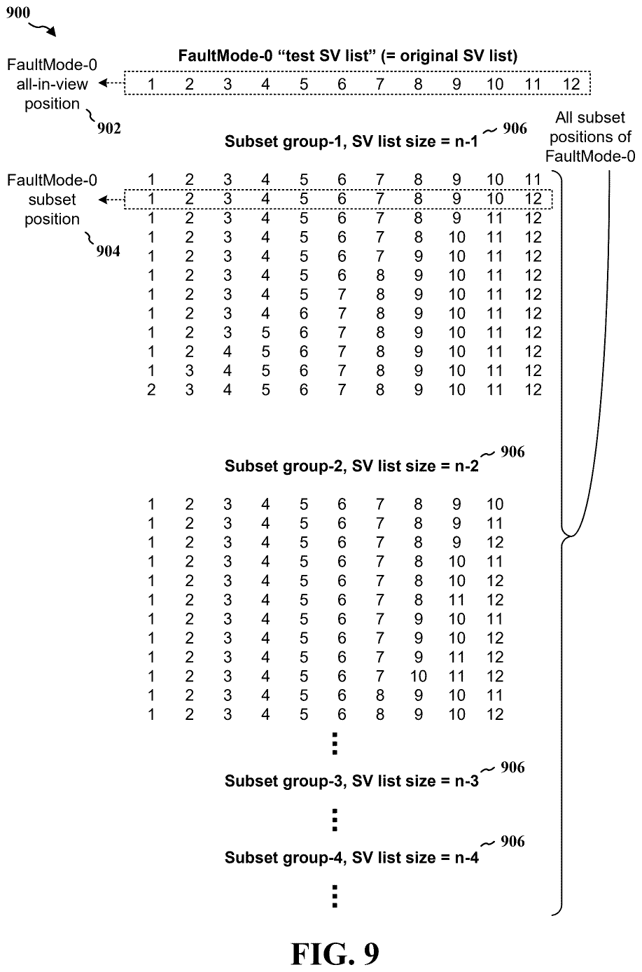

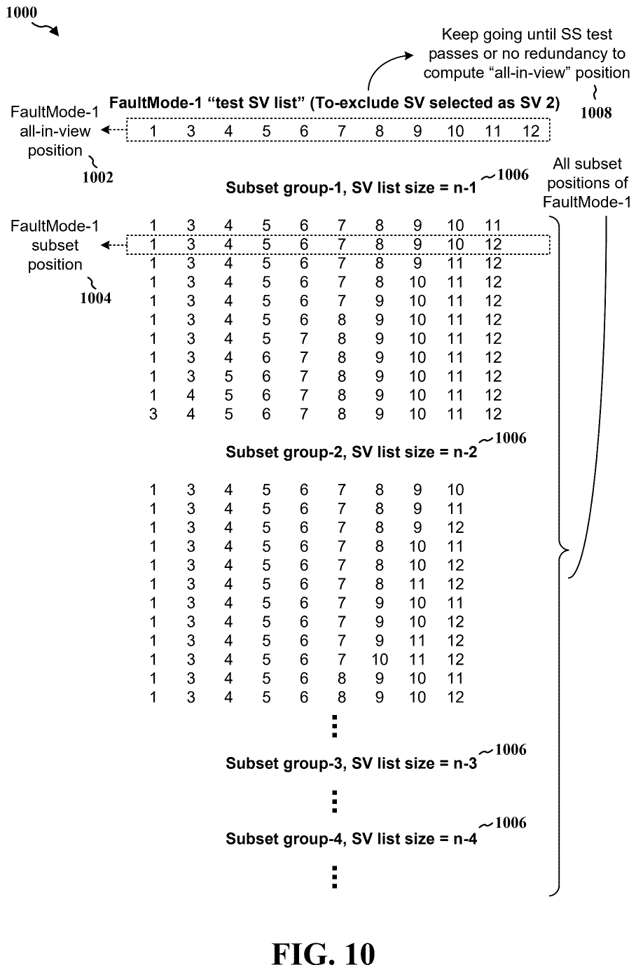

FIG. 8 is a diagram 800 illustrating an example SS RAIM implementation in accordance with various aspects of the present disclosure. Aspects presented herein may be performed by a GNSS device 802, such as a UE, and may be illustrated in conjunction with diagrams 900 and 1000 of FIGS. 9 and 10.

As shown at 810, when the GNSS device 802 is configured to perform SS RAIM, the GNSS device 802 may initially start with a list of SVs, which may be referred to as the “original SV list.” For purposes of illustration, assuming the original SV list has twelve (12) SVs, SV 1 to SV 12.

At 812, the GNSS device 802 may start an SS test based on evaluating the original SV list (e.g., evaluating SV 1 to SV 12), where the list of SVs that is evaluated during the SS test may be referred to as the “test SV list.” For purposes of illustration, this (first/initial) SS test may be referred to as a “fault mode 0 (FaultMode-0)” where “test SV list”=“original SV list” (e.g., both the test SV list and the original SV list include SV 1 to SV 12).

At 814, an all-in-view position generator (module) may generate an all-in-view position (of the GNSS device 802) based on using all SVs in the test SV list (e.g., using SV 1 to SV 12), and output an all-in-view position as shown at 816. This all-in-view position may be referred to as the “FaultMode-0 all-in-view position” as shown at 902 of FIG. 9.

At 818, a subset position generator (module) may generate a plurality of subset positions (of the GNSS device 802) based on different combinations of subsets of SVs in the test SV list (e.g., SV 1 to SV 12), such as different combinations of eleven SVs, ten SVs, nine SVs, etc., and output the plurality of subset positions as shown at 820. The plurality of subset positions may be referred to as the “FaultMode-0 subset positions” as shown at 904 of FIG. 9. As shown at 906 of FIG. 9, for a subset-group-i, the possible combination count of the subset-group-i (C (n, i)) may be calculated based on:

$$C ( n , i ) = \frac{n !}{( n - i ) ! * i !}$$

where n is the size of “test SV list,” i is the size of the subset-group-i SV list, and! is the factorial operator. The total number/count of subset of positions may be calculated based on:

$${\sum }_{i = 1}^{n - 1} C ( n , i ) = {2}^{n} - 2$$

In some implementations, as shown at 822, a least square (LSQ) module (or an LSQ estimation module) may be configured to provide LSQ information to the all-in-view position generator (module) and/or the subset position generator (module), where the LSQ information may include the design, the pre-fit, the measurement uncertainties, etc. For example, LSQ may be one common approach to estimate the unknown states with positioning measurements. To run LSQ, some LSQ information may be specified, such as (1) design matrix—the linear mapping relationship between unknown estimates and the measurements, (2) pre-fit residuals-adjusted measurement for estimation based on approximate value of the unknown state, and (3) measurement uncertainty—this uncertainty information may be used to optimize the LSQ estimation results. As such, to calculate the all-in-view and subset positions, those LSQ information may be demanded.

At 824, the GNSS device 802 may perform an “SS evaluation” by comparing the “FaultMode-0 all-in-view position” with all “FaultMode-0 subset positions,” and determine whether the comparison between the FaultMode-0 all-in-view position and any of the FaultMode-0 subset positions shows a difference that is greater than a defined threshold (e.g., “FaultMode-0 all-in-view position” vs. “FaultMode-0 subset position”>threshold).

As shown at 826, if the comparisons between the FaultMode-0 all-in-view position and all FaultMode-0 subset positions do not show any of the comparisons has a difference that is greater than the defined threshold, the SVs in the test SV list (e.g., SV 1 to SV 12) are considered to pass the SS evaluation, and the GNSS device 802 may report the FaultMode-0 all-in-view position as the output. Typically, if the GNSS device 802 is under an open sky environment and there is no outlier in measurements, the “SS evaluation” is likely to pass.

On the other hand, if the GNSS device 802 is in a challenging environment (e.g., in an urban area surrounded by tall buildings) and measurements are subjected to multi-path (MP) effects, then “SS evaluation” is likely or expected to fail. In other words, one or more comparisons between the FaultMode-0 all-in-view position and all FaultMode-0 subset positions are likely to show a difference that is greater than the defined threshold.

As shown at 828, 830, and 832, if the SS evaluation for the test SV list fails (e.g., SS test for fault mode 0 fails), the GNSS device 802 may begin an iteration to shrink the “test SV list.” For example, as shown at 1002 of FIG. 10, the GNSS device 802 may start with “fault mode 1 (FaultMode-1),” where one SV is removed from the “original SV list” to generate a new “test SV list.” For purposes of illustration, assuming SV 2 is removed from the original SV list of SV 1 to SV 12. As such, the new test SV list now includes SV 1 and SV 3 to SV 12 (a total of eleven SVs). In other words, “test SV list”!=“original SV list,” and “test SV list”=“original SV list”−“to-exclude SV list.” Then, the GNSS device 802 may perform the SS test based on the new test SV list (e.g., SV 1 and SV 3 to SV 12), such as repeating the process described in connection with 812 to 824.

Depending on implementations, the criteria to select the “to-exclude SV list” (e.g., the SV(s) to be excluded in the next/subsequent SS test), multiple “to-exclude SV list” may exists, but the GNSS device 802 may be configured to select just one. In some examples, the selection of an SV to be excluded (e.g., the selection of the “to-exclude SV list”) may be based on the SS test results (e.g., SS test fault mode 0 results). For example, the GNSS device 802 may be configured to select the SV (e.g., the “to-exclude SV list”) with the smallest weighted sum of squared residual (WSS) values, which may be calculated based on:

$$W S S = {V}^{T} P V$$

where V is the post-fit residual, and P is the weighting matrix.

At 812, the GNSS device 802 may start an SS test based on evaluating the new test SV list (e.g., evaluating SV 1 and SV 3 to SV 12). For purposes of illustration, this SS test may be referred to as a “fault mode 1 (FaultMode-1).”

At 814, the all-in-view position generator (module) may generate an all-in-view position (of the GNSS device 802) based on using all SVs in the test SV list (e.g., SV 1 and SV 3 to SV 12), and output an all-in-view position as shown at 816. This all-in-view position may be referred to as the “FaultMode-1 all-in-view position” as shown at 1002 of FIG. 10.

At 818, the subset position generator (module) may generate a plurality of subset positions (of the GNSS device 802) based on different combinations of subsets of SVs in the test SV list (e.g., SV 1 and SV 3 to SV 12), such as different combinations of ten SVs, nine SVs, eight SVs, etc., and output the plurality of subset positions as shown at 820. The plurality of subset positions may be referred to as the “FaultMode-1 subset positions” as shown at 1004 of FIG. 10.

At 824, the GNSS device 802 may perform an “SS evaluation” by comparing the “FaultMode-1 all-in-view position” with all “FaultMode-1 subset positions,” and determine whether the comparison between the FaultMode-1 all-in-view position and any of the FaultMode-1 subset positions shows a difference that is greater than a defined threshold (e.g., “FaultMode-1 all-in-view position” vs. “FaultMode-1 subset position”>threshold).

Similarly, as shown at 826, if the comparisons between the FaultMode-1 all-in-view position and all FaultMode-1 subset positions do not show any of the comparisons has a difference that is greater than the defined threshold, the SVs in the test SV list (e.g., SV 1 and SV 3 to SV 12) are considered to pass the SS evaluation, and the GNSS device 802 may report the FaultMode-1 all-in-view position as the output. On the other hand, if at least one comparison between the FaultMode-1 all-in-view position and all FaultMode-1 subset positions shows a difference that is greater than the defined threshold, the SS evaluation for the test SV list fails (e.g., SS test for fault mode 1 fails). Then, at 828, 830, and 832, the GNSS device 802 may begin another iteration to shrink the “test SV list.” For example, the GNSS device 802 may start with “fault mode 2 (FaultMode-2),” where another SV is removed from the “test SV list” (e.g., the one that include SV 1 and SV 3 to SV 12) to generate another new “test SV list.” For purposes of illustration, assuming SV 12 is removed from the test SV list of SV 1 and SV 3 to SV 12. As such, the new test SV list now includes SV 1 and SV 3 to SV 11 (a total of ten SVs). Similarly, the selection of the SV to be excluded (e.g., the selection of the “to-exclude SV list”) may be based on the SS test results (e.g., SS test fault mode 1 results). For example, the GNSS device 802 may be configured to select the SV (e.g., the “to-exclude SV list”) with the smallest WSS values.

As shown at 1008 of FIG. 10, the GNSS device 802 may iterate the process described in connection with 812 to 832, and the iteration may stop until a test SV list passes the “SS test” (e.g., the GNSS device 802 is able to output a valid position at 826 based on the test SV list). In some examples, the iteration may also stop if there is not enough redundancy to compute the “all-in-view position,” then the GNSS device 802 may output the position as not available (N/A). For example, the GNSS device 802 may specify at least five SVs for calculating the all-in-view position.

While the SS RAIM mechanism discussed in connection with FIGS. 8 to 10 theoretically sound, and designed for SV and constellation failure, this SS RAIM mechanism may not practically work well to detect MP outlier(s). For example, for this SS RAIM mechanism, there may be no or not enough quality check (such as just include position dilution of precision (PDOP) check) for the “subset positions” and the “all-in-view position.” This SS RAIM mechanism may also allow more low accuracy “subset positions” to participate the “SS evaluation,” which may increase the frequency for the SS evaluation to fail (e.g., the test SV list is easier to fail at the “SS evaluation”). In some scenarios, the “to-exclude SV list” selector module (e.g., as shown at 828 of FIG. 8) may provide misleading information, if it is configured to purely based on selecting the SV to be excluded using the smallest WSS selection strategy (e.g., smallest WSS may come from low accuracy “subset positions”). As such, in some scenarios, the SS RAIM mechanism discussed in connection with FIGS. 8 to 10 may be more likely to cause the GNSS device 802 to output an N/A for the position, or this SS RAIM mechanism/solution may not be able to identify the outlier(s) correctly, and may trigger hazardously misleading information (HMI) for GNSS integrity output.

Aspects presented herein may improve the overall performance of SS RAIM (or the overall performance of a positioning engine configured to perform SS RAIM) by enabling the “all-in-view position” and the “subsets positions” calculated by the SS RAIM to be validated (e.g., by a position validator module) to eliminate certain low accuracy “subset positions” and/or “all-in-view position” from an SS evaluation. For example, in one aspect, a position validator module may be configured to check whether there is any outlier(s) in the “all-in-view position” and the “subsets positions” based on whether their WSS follows a chi-square (Chi2) distribution, and also use a residual MP sign check to detect the outlier(s). As such, aspects presented herein may enable early exit for some fault modes of the SS RAIM, and also improve the computation efficiency for the SS RAIM. For example, based on validating the “all-in-view position” and the “subsets positions,” the SS RAIM may permit just high accuracy “subset positions” to participate the SS evaluation, thereby enabling a list of SVs to have a higher chance of passing the SS evaluation. Aspects presented herein may also enable the SS RAIM to have a less chance of selecting a wrong or improper SV to be excluded in a subsequent SS test.

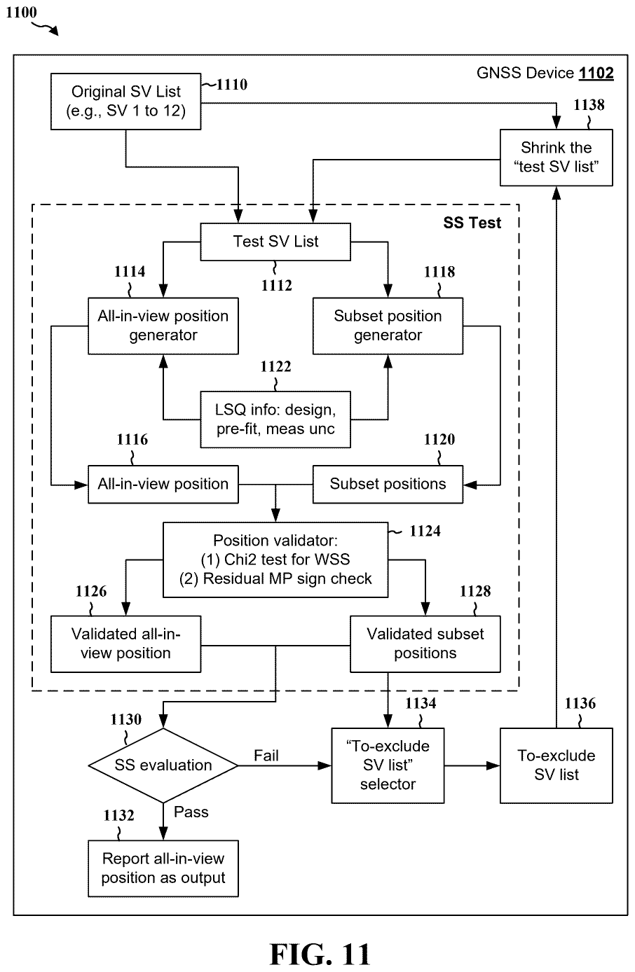

FIG. 11 is a diagram 1100 illustrating an example SS RAIM implementation with a position validator capable of validating outlier(s) in all-in-view position and subset positions in accordance with various aspects of the present disclosure. For differentiation purposes, the SS RAIM described herein may be referred to as the “enhanced SS RAIM.” Aspects presented herein may be performed by a GNSS device 1102, such as a UE.

As shown at 1110, if the GNSS device 1102 (or a PE/PPE of the GNSS device 1102) is configured to perform SS RAIM, the GNSS device 1102 may initially start with a list of SVs, which may be referred to as the “original SV list.” For purposes of illustration, assuming the original SV list has twelve (12) SVs, SV 1 to SV 12.

At 1112, the GNSS device 1102 may start an SS test based on evaluating the original SV list (e.g., evaluating SV 1 to SV 12), where the list of SVs that is evaluated during the SS test may be referred to as the “test SV list.” For purposes of illustration, this (first/initial) SS test may be referred to as a “fault mode 0 (FaultMode-0)” where “test SV list”=“original SV list” (e.g., both the test SV list and the original SV list include SV 1 to SV 12).

At 1114, an all-in-view position generator (module) may generate an all-in-view position (of the GNSS device 1102) based on using all SVs in the test SV list (e.g., using SV 1 to SV 12), and output an all-in-view position as shown at 1116. This all-in-view position may be referred to as the “FaultMode-0 all-in-view position” (e.g., as shown at 902 of FIG. 9).

At 1118, a subset position generator (module) may generate a plurality of subset positions (of the GNSS device 1102) based on different combinations of subsets of SVs in the test SV list (e.g., SV 1 to SV 12), such as different combinations of eleven SVs, ten SVs, nine SVs, etc., and output the plurality of subset positions as shown at 1120. The plurality of subset positions may be referred to as the “FaultMode-0 subset positions” (e.g., as shown at 904 of FIG. 9).

In some implementations, as shown at 1122, an LSQ module may be configured to provide LSQ information to the all-in-view position generator (module) and/or the subset position generator (module), where the LSQ information may include the design, the pre-fit, the measurement uncertainties, etc.

At 1124, a position validator (module) may be configured to determine whether there are outlier(s) in the FaultMode-0 all-in-view position and the FaultMode-0 subset positions based on performing at least one of (1) a chi-square (Chi2 or ×2) test for WSS of the FaultMode-0 all-in-view position and the FaultMode-0 subset positions, or (2) a residual multi-path (MP) sign check for the FaultMode-0 all-in-view position and the FaultMode-O subset positions.

As discussed in connection with 828, 830, and 832 of FIG. 8, the SS RAIM may include calculating the WSS values for subset positions based on WSS=VT PV, where V is the post-fit residual, and P is the weighting matrix.

In one aspect of the present disclosure, the position validator may be configured to perform a chi-square test for the FaultMode-0 all-in-view position and the FaultMode-0 subset positions by checking whether the distribution of WSS values follow a chi-square distribution. If there are no outlier in the FaultMode-0 all-in-view position and the FaultMode-0 subset positions, the distribution of WSS values is expected to follow the chi-square distribution.

Chi-square (Chi2) may refer to a statistical measure that may be used to assess the association between categorical variables or to compare observed data with data expected based on a specific hypothesis. It may be commonly used in tests of goodness-of-fit (e.g., determining if a sample matches a population or if the observed distribution of categorical data fits an expected distribution), tests of independence (e.g., assessing whether two categorical variables are independent of each other in a contingency table), and/or tests for homogeneity (e.g., testing if different populations have the same distribution of a categorical variable). The chi-square value may reflect how much the observed data deviate from the expected data.

A chi-square distribution may refer to a continuous probability distribution that arises in statistics when estimating the variance of a normally distributed population. It may be positively skewed, meaning that it may not be symmetric, especially for smaller degrees of freedom. As the degrees of freedom increase, the distribution approaches a normal distribution. The degrees of freedom (df) of the distribution refer to the number of values that are free to vary in the calculation. Characteristics of a chi-square distribution may include just taking positive values, the shape depends on the degrees of freedom, and typically used in hypothesis testing for categorical data. The chi-square test may help determining whether any observed deviations between the observed and expected frequencies are due to chance or indicate a statistically significant difference.

As such, when there is no outlier in the FaultMode-0 all-in-view position and the FaultMode-0 subset positions, their WSS are expected to follow the chi-square distribution. On the other hand, if the WSS of a position (e.g., an all-in-view position or a subset position) is greater than a chi-square threshold (WSS >Chi2-threshold), it may indicate that the position is affected by the outlier. In that case, the position validator (or the SS RAIM/GNSS device 1102) may exclude the position whose WSS is great than the chi-square threshold from the SS evaluation (and keep position whose WSS is smaller than the chi-square threshold in the SS evaluation).

In another aspect of the present disclosure, the position validator may be configured to perform a residual MP sign check for the FaultMode-0 all-in-view position and the FaultMode-0 subset positions by checking whether their residual is positive (+) or negative (−). If the residual value for a position is negative, the position validator (or the SS RAIM/GNSS device 1102) may exclude the position from the SS evaluation.

As discussed above, a “subset position” is calculated using a subset of SVs in the test SV list. By using this “subset position,” the SS RAIM/GNSS device 1102 may re-compute the residual for the original SV list (e.g., SV 1 to SV 12) (which may be referred to as the “computed residual”). In the context of GNSS positioning, a residual may refer to the difference between the observed (measured) value of a position-related parameter (e.g., a satellite pseudorange, phase measurement) and its predicted or estimated (e.g., calculated) value based on a positioning model.

If this “subset position” is accurate, then its ground truth (GT) residual may reflect the GNSS measurement outlier. As discussed above, in PE/PPE, one major outlier may be caused by the MP, and the residual value for MP is (always) a positive value. Therefore, if any of the “computed residual” shows a negative value, and also the absolute value of the “computed residual” is greater than a defined threshold (“computed residual” absolute value is >threshold (e.g., 15 m)), then it may be indicative that a “subset position” is not accurate. As such, the position validator (or the SS RAIM/GNSS device 1102) may exclude this subset position from the SS evaluation.

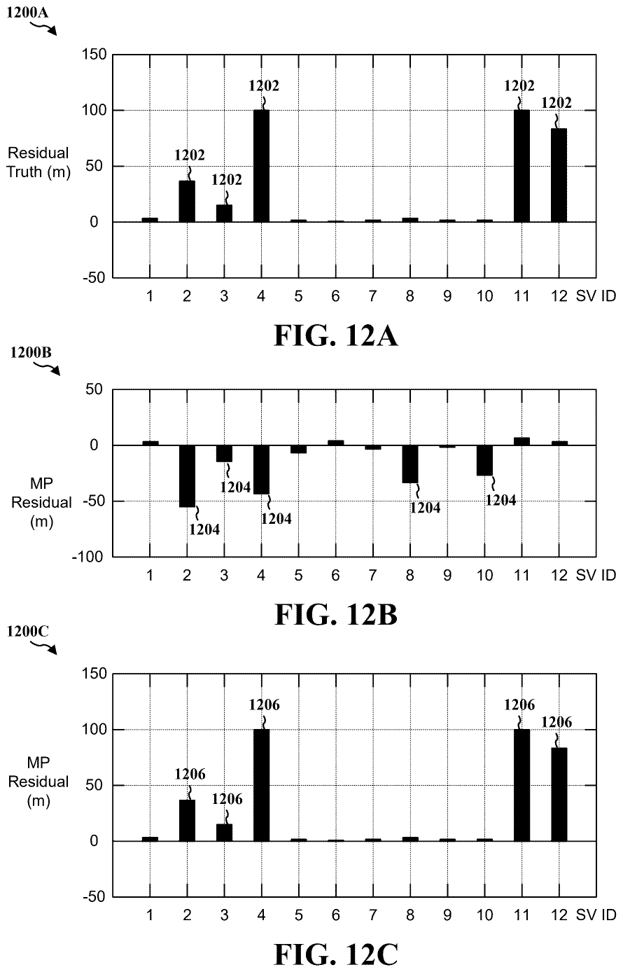

FIG. 12A is a diagram 1200A illustrating an example residual truth for SVs in accordance with various aspects of the present disclosure. As mentioned above, a residual may refer to the difference between “the observed” and “the calculated/estimated” values. The “residual truth” may refer to “the calculated/estimated” value that is obtained using a ground truth (GT) position. When an SV is affected by MP, the residual truth value of the SV is expected to be a positive value. For example, assuming SVs 2, 3, 4, 11, and 12 in the original SV list are affected by MP, as shown at 1202, their residual truth are positive values, which may reflect the actual outlier due to MP.

FIG. 12B is a diagram 1200B illustrating an example MP residual for SVs in accordance with various aspects of the present disclosure. As shown at 1204, when a residual is computed using a low accuracy “subset position,” the MP residuals for some SVs may reflect negative values. This means this subset position fails the residual MP sign check, and the position validator (or the SS RAIM/GNSS device 1102) may exclude this subset position from the SS evaluation.

FIG. 12C is a diagram 1200C illustrating an example MP residual for SVs in accordance with various aspects of the present disclosure. As shown at 1206, when a residual is computed using a high accuracy “subset position,” the MP residuals for some SVs may reflect positive values (e.g., similar to the residual truth shown by diagram 1200A of FIG. 12A). This means this subset position passes the residual MP sign check, and the position validator (or the SS RAIM/GNSS device 1102) may include this subset position in the SS evaluation.

Referring back to FIG. 11, after performing the chi-square test for WSS and/or the residual MP sign check for the FaultMode-0 all-in-view position and FaultMode-0 subset positions, as shown at 1126, the position validator may output the FaultMode-0 all-in-view position if it passes the chi-square test for WSS and the residual MP sign check (which may be referred to as the “validated FaultMode-0 all-in-view position”), and as shown at 1128, the position validator may also output FaultMode-0 subset positions that pass the chi-square test for WSS and the residual MP sign check (which may be referred to as the “validated FaultMode-0 subset positions”). In other words, the “position validator” module may be configured to perform two types of checks: (1) Chi2 test for WSS and (2) residual MP sign check. If any of these two checks fail, the “position validator” may not pass. For example, if “all-in-view position” is unable to pass the “position validator,” the current setting of the SS test may exit and move to next setting of SS test with a “reduced test SV list”. If a “subset position/solution” is unable to pass the “position validator”, this “subset position/solution” may be eliminated from the current SS test (or SS evaluation).

At 1130, the GNSS device 1102 may perform the SS evaluation” by comparing the “validated FaultMode-0 all-in-view position” with all “validated FaultMode-0 subset positions,” and determine whether the comparison between the validated FaultMode-0 all-in-view position and any of the validated FaultMode-0 subset positions shows a difference that is greater than a defined threshold (e.g., “validated FaultMode-0 all-in-view position” vs. “validated FaultMode-0 subset position”>threshold).

As shown at 1132, if the comparisons between the validated FaultMode-0 all-in-view position and all validated FaultMode-0 subset positions do not show any of the comparisons has a difference that is greater than the defined threshold, the SVs in the test SV list (e.g., SV 1 to SV 12) are considered to pass the SS evaluation, and the GNSS device 1102 may report the validated FaultMode-0 all-in-view position as the output. On the other hand, if the comparison between the validated FaultMode-0 all-in-view position and a validated FaultMode-0 subset position has a difference that is greater than the defined threshold, the SVs in the test SV list (e.g., SV 1 to SV 12) fail the SS evaluation.

As shown at 1134, 1136, and 1138, if the SS evaluation for the test SV list fails (e.g., SS test for fault mode 0 fails), the GNSS device 1102 may begin an iteration to shrink the “test SV list,” such as described in connection with 828, 830, and 832 of FIG. 8. For example, as shown at 1002 of FIG. 10, the GNSS device 1102 may start with “fault mode 1 (FaultMode-1),” where one SV is removed from the “original SV list” to generate a new “test SV list.” For purposes of illustration, assuming SV 2 is removed from the original SV list of SV 1 to SV 12. As such, the new test SV list now includes SV 1 and SV 3 to SV 12 (a total of eleven SVs). In other words, “test SV list”!=“original SV list,” and “test SV list”=“original SV list”−“to-exclude SV list.” Then, the GNSS device 1102 may perform the SS test based on the new test SV list (e.g., SV 1 and SV 3 to SV 12), such as repeating the process described in connection with 1112 to 1130. Depending on implementations, the GNSS device 1102 may be configured to loop all possible SS evaluation/test (e.g., instead of selecting the SV with the smallest WSS values as discussed in connection with FIG. 8).

The enhanced SS RAIM discussed in connection with FIG. 11 may improve the overall performance of positioning compared to the SS RAIM discussed in connection with FIG. 8. For example, by using the enhanced SS RAIM in a challenging environment, a GNSS device may bring down the position error from hundreds meter to less than three (3) meters.

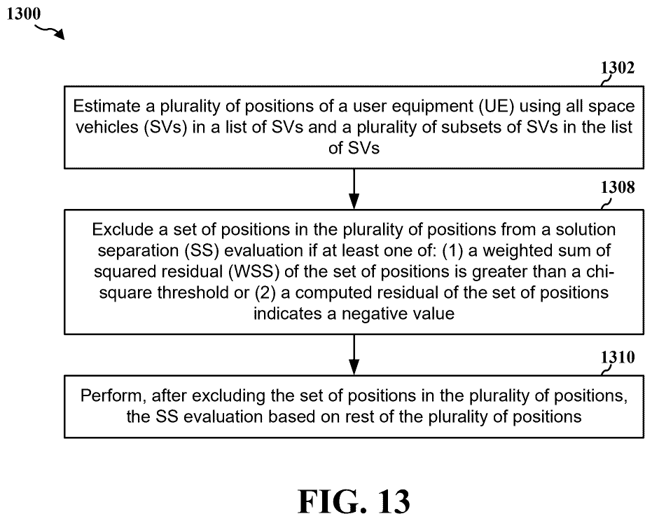

FIG. 13 is a flowchart 1300 of a method of positioning at a user equipment (UE). The method may be performed by a UE (e.g., the UE 104, 404; the GNSS device 506, 1102; the apparatus 1504). The method may enable the UE to validate the “all-in-view position” and the “subsets positions” calculated by the SS RAIM and eliminate certain low accuracy “subset positions” and/or “all-in-view position” from an SS evaluation based on the validation, thereby enabling early exit for some fault modes of the SS RAIM, and improving the computation efficiency for the SS RAIM.

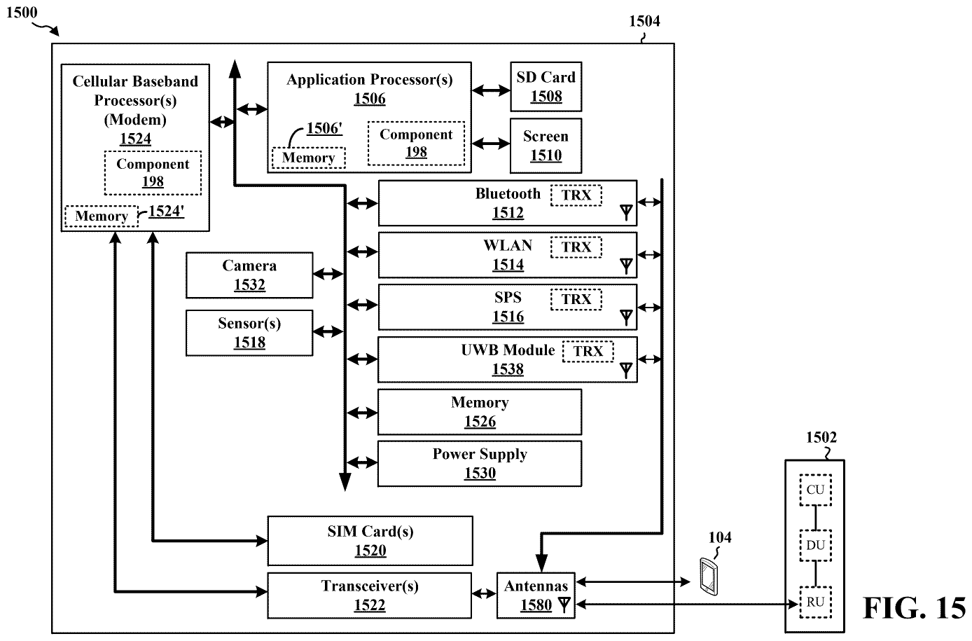

At 1302, the UE may estimate a plurality of positions of the UE using all SVs in a list of SVs and a plurality of subsets of SVs in the list of SVs, such as described in connection with FIG. 11. For example, at 1114, an all-in-view position generator (module) may generate an all-in-view position (of the GNSS device 1102) based on using all SVs in the test SV list (e.g., using SV 1 to SV 12), and output an all-in-view position as shown at 1116. At 1118, a subset position generator (module) may generate a plurality of subset positions (of the GNSS device 1102) based on different combinations of subsets of SVs in the test SV list (e.g., SV 1 to SV 12), such as different combinations of eleven SVs, ten SVs, nine SVs, etc., and output the plurality of subset positions as shown at 1120. The estimation of the plurality of positions of the UE may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

At 1308, the UE may exclude a set of positions in the plurality of positions from an SS evaluation if at least one of: (1) a WSS of the set of positions is greater than a chi-square threshold or (2) a computed residual of the set of positions indicates a negative value, such as described in connection with FIG. 11. For example, at 1124, a position validator (module) may be configured to determine whether there are outlier(s) in the FaultMode-0 all-in-view position and the FaultMode-0 subset positions based on performing at least one of (1) a chi-square (Chi2 or χ2) test for WSS of the FaultMode-0 all-in-view position and the FaultMode-0 subset positions, or (2) a residual multi-path (MP) sign check for the FaultMode-0 all-in-view position and the FaultMode-0 subset positions. The position validator (or the SS RAIM/GNSS device 1102) may exclude the position whose WSS is great than the chi-square threshold from the SS evaluation (and keep position whose WSS is smaller than the chi-square threshold in the SS evaluation). Similarly, if any of the “computed residual” shows a negative value, and also the absolute value of the “computed residual” is greater than a defined threshold (“computed residual” absolute value is >threshold (e.g., 15 m)), then it may be indicative that a “subset position” is not accurate. As such, the position validator (or the SS RAIM/GNSS device 1102) may exclude this subset position from the SS evaluation. The exclusion of the set of positions may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

At 1310, the UE may perform, after excluding the set of positions in the plurality of positions, the SS evaluation based on rest of the plurality of positions, such as described in connection with FIG. 11. For example, at 1130, the GNSS device 1102 may perform the SS evaluation” by comparing the “validated FaultMode-0 all-in-view position” with all “validated FaultMode-0 subset positions,” and determine whether the comparison between the validated FaultMode-0 all-in-view position and any of the validated FaultMode-0 subset positions shows a difference that is greater than a defined threshold (e.g., “validated FaultMode-0 all-in-view position” vs. “validated FaultMode-0 subset position”>threshold). The SS evaluation may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

In one example, the UE may calculate the WSS for each position in the plurality of positions, and compare the calculated WSS for each position in the plurality of positions with the chi-square threshold, such as described in connection with FIG. 11. For example, at 1124, the position validator may be configured to perform a chi-square test for the FaultMode-0 all-in-view position and the FaultMode-0 subset positions by checking whether the distribution of WSS values follow a chi-square distribution. If there are no outlier in the FaultMode-0 all-in-view position and the FaultMode-0 subset positions, the distribution of WSS values is expected to follow the chi-square distribution. The calculation of the WSS may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

In another example, the UE may compute a residual value for each position in the plurality of positions, and determine whether the computed residual value for each position in the plurality of positions is the negative value, such as described in connection with FIG. 11. For example, at 1124, the position validator may be configured to perform a residual MP sign check for the FaultMode-0 all-in-view position and the FaultMode-0 subset positions by checking whether their residual is positive (+) or negative (−). If the residual value for a position is negative, the position validator (or the SS RAIM/GNSS device 1102) may exclude the position from the SS evaluation. The computation of the residual value may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

In another example, the UE may output, based on the SS evaluation, an indication of: (1) using a position estimated from all SVs in the list of SVs, or (2) removing an SV from the list of SVs for a subsequent SS test, such as described in connection with FIG. 11. For example, at 1132, if the comparisons between the validated FaultMode-0 all-in-view position and all validated FaultMode-0 subset positions do not show any of the comparisons has a difference that is greater than the defined threshold, the SVs in the test SV list (e.g., SV 1 to SV 12) are considered to pass the SS evaluation, and the GNSS device 1102 may report the validated FaultMode-0 all-in-view position as the output. On the other hand, if the comparison between the validated FaultMode-0 all-in-view position and a validated FaultMode-0 subset position has a difference that is greater than the defined threshold, the SVs in the test SV list (e.g., SV 1 to SV 12) fail the SS evaluation. As shown at 1134, 1136, and 1138, if the SS evaluation for the test SV list fails (e.g., SS test for fault mode 0 fails), the GNSS device 1102 may begin an iteration to shrink the “test SV list.” The output of the indication may be performed by, e.g., the SS RAIM component 198, the SPS module 1516, the transceiver(s) 1522, the cellular baseband processor(s) 1524, and/or the application processor(s) 1506 of the apparatus 1504 in FIG. 15. In some implementations, to output the indication of: (1) using the position estimated from all SVs in the list of SVs, or (2) removing an SV from the list of SVs for the subsequent SS test, the UE may be configured to transmit the indication of: (1) using the position estimated from all SVs in the list of SVs, or (2) removing an SV from the list of SVs for the subsequent SS test, or store the indication of: (1) using the position estimated from all SVs in the list of SVs, or (2) removing an SV from the list of SVs for the subsequent SS test.

In another example, to estimate the plurality of positions of the UE using all SVs in the list of SVs and the plurality of subsets of SVs in the list of SVs, the UE may be configured to estimate a first position of the UE using all SVs in the list of SVs, and estimate a set of second positions of the UE using the plurality of subsets of SVs in the list of SVs.

In another example, the SS evaluation is associated with SS RAIM.

In another example, to perform the SS evaluation based on the rest of the plurality of positions, the UE may be configured to compare a first validated position in the rest of the plurality of positions with each of a plurality of second validated positions in the rest of the plurality of positions, and enable the SS evaluation to pass if a difference between each comparison does not exceed a difference threshold, or enable the SS evaluation to fail if the difference for at least one comparison exceeds the difference threshold. In some implementations, the first validated position corresponds to a first position of the UE estimated using all SVs in the list of SVs, where the WSS of the first position is less than the chi-square threshold and the computed residual for the first position is a positive value. In some implementations, a second validated position in the plurality of second validated positions corresponds to a second position of the UE estimated using a subset of SVs in the list of SVs, where the WSS of the second position is less than the chi-square threshold and the computed residual for the second position is a positive value.

In another example, to estimate the plurality of positions of the UE using all SVs in the list of SVs and the plurality of subsets of SVs in the list of SVs, the UE may be configured to measure signals from all SVs in the list of SVs, and estimate the plurality of positions of the UE based on the measurements.

In another example, the UE may determine that the WSS for each position in the set of positions is greater than the chi-square threshold, and to exclude the set of positions in the plurality of positions from the SS evaluation, the UE may be configured to exclude the set of positions in the plurality of positions from the SS evaluation based on the determination that each position in the set of positions is greater than the chi-square threshold.

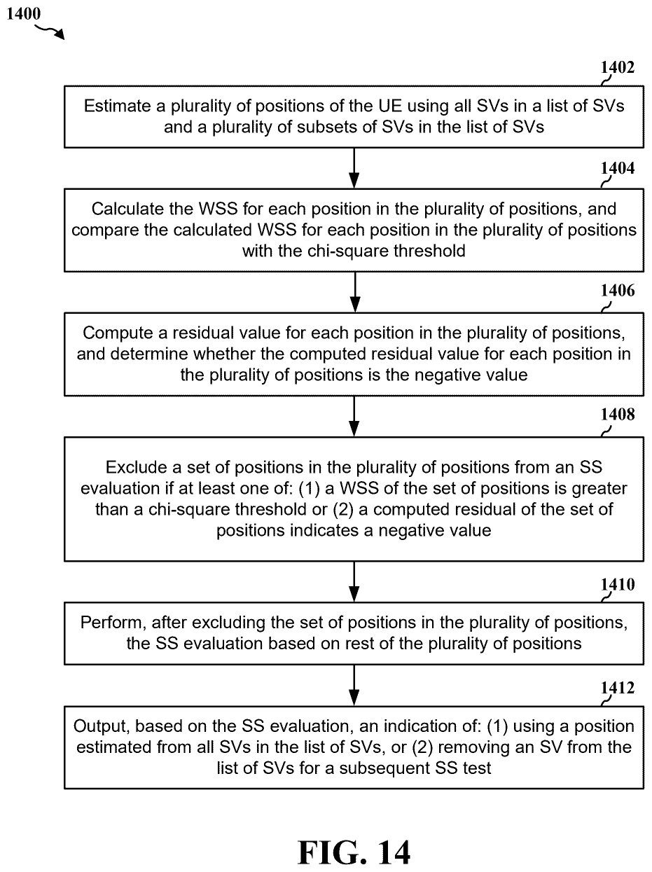

FIG. 14 is a flowchart 1400 of a method of positioning at a user equipment (UE). The method may be performed by a UE (e.g., the UE 104, 404; the GNSS device 506, 1102; the apparatus 1504). The method may enable the UE to validate the “all-in-view position” and the “subsets positions” calculated by the SS RAIM and eliminate certain low accuracy “subset positions” and/or “all-in-view position” from an SS evaluation based on the validation, thereby enabling early exit for some fault modes of the SS RAIM, and improving the computation efficiency for the SS RAIM.

At 1402, the UE may estimate a plurality of positions of the UE using all SVs in a list of SVs and a plurality of subsets of SVs in the list of SVs, such as described in connection with FIG. 11. For example, at 1114, an all-in-view position generator (module) may generate an all-in-view position (of the GNSS device 1102) based on using all SVs in the test SV list (e.g., using SV 1 to SV 12), and output an all-in-view position as shown at 1116. At 1118, a subset position generator (module) may generate a plurality of subset positions (of the GNSS device 1102) based on different combinations of subsets of SVs in the test SV list (e.g., SV 1 to SV 12), such as different combinations of eleven SVs, ten SVs, nine SVs, etc., and output the plurality of subset positions as shown at 1120. The estimation of the plurality of positions of the UE may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

At 1408, the UE may exclude a set of positions in the plurality of positions from an SS evaluation if at least one of: (1) a WSS of the set of positions is greater than a chi-square threshold or (2) a computed residual of the set of positions indicates a negative value, such as described in connection with FIG. 11. For example, at 1124, a position validator (module) may be configured to determine whether there are outlier(s) in the FaultMode-0 all-in-view position and the FaultMode-0 subset positions based on performing at least one of (1) a chi-square (Chi2 or χ2) test for WSS of the FaultMode-0 all-in-view position and the FaultMode-0 subset positions, or (2) a residual multi-path (MP) sign check for the FaultMode-0 all-in-view position and the FaultMode-0 subset positions. The position validator (or the SS RAIM/GNSS device 1102) may exclude the position whose WSS is great than the chi-square threshold from the SS evaluation (and keep position whose WSS is smaller than the chi-square threshold in the SS evaluation). Similarly, if any of the “computed residual” shows a negative value, and also the absolute value of the “computed residual” is greater than a defined threshold (“computed residual” absolute value is >threshold (e.g., 15 m)), then it may be indicative that a “subset position” is not accurate. As such, the position validator (or the SS RAIM/GNSS device 1102) may exclude this subset position from the SS evaluation. The exclusion of the set of positions may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

At 1410, the UE may perform, after excluding the set of positions in the plurality of positions, the SS evaluation based on rest of the plurality of positions, such as described in connection with FIG. 11. For example, at 1130, the GNSS device 1102 may perform the SS evaluation” by comparing the “validated FaultMode-0 all-in-view position” with all “validated FaultMode-0 subset positions,” and determine whether the comparison between the validated FaultMode-0 all-in-view position and any of the validated FaultMode-0 subset positions shows a difference that is greater than a defined threshold (e.g., “validated FaultMode-0 all-in-view position” vs. “validated FaultMode-0 subset position”>threshold). The SS evaluation may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

In one example, as shown at 1404, the UE may calculate the WSS for each position in the plurality of positions, and compare the calculated WSS for each position in the plurality of positions with the chi-square threshold, such as described in connection with FIG. 11. For example, at 1124, the position validator may be configured to perform a chi-square test for the FaultMode-0 all-in-view position and the FaultMode-0 subset positions by checking whether the distribution of WSS values follow a chi-square distribution. If there are no outlier in the FaultMode-0 all-in-view position and the FaultMode-0 subset positions, the distribution of WSS values is expected to follow the chi-square distribution. The calculation of the WSS may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

In another example, as shown at 1406, the UE may compute a residual value for each position in the plurality of positions, and determine whether the computed residual value for each position in the plurality of positions is the negative value, such as described in connection with FIG. 11. For example, at 1124, the position validator may be configured to perform a residual MP sign check for the FaultMode-0 all-in-view position and the FaultMode-0 subset positions by checking whether their residual is positive (+) or negative (−). If the residual value for a position is negative, the position validator (or the SS RAIM/GNSS device 1102) may exclude the position from the SS evaluation. The computation of the residual value may be performed by, e.g., the SS RAIM component 198, the SPS module 1516, the transceiver(s) 1522, the cellular baseband processor(s) 1524, and/or the application processor(s) 1506 of the apparatus 1504 in FIG. 15.

In another example, as shown at 1412, the UE may output, based on the SS evaluation, an indication of: (1) using a position estimated from all SVs in the list of SVs, or (2) removing an SV from the list of SVs for a subsequent SS test, such as described in connection with FIG. 11. For example, at 1132, if the comparisons between the validated FaultMode-0 all-in-view position and all validated FaultMode-0 subset positions do not show any of the comparisons has a difference that is greater than the defined threshold, the SVs in the test SV list (e.g., SV 1 to SV 12) are considered to pass the SS evaluation, and the GNSS device 1102 may report the validated FaultMode-0 all-in-view position as the output. On the other hand, if the comparison between the validated FaultMode-0 all-in-view position and a validated FaultMode-0 subset position has a difference that is greater than the defined threshold, the SVs in the test SV list (e.g., SV 1 to SV 12) fail the SS evaluation. As shown at 1134, 1136, and 1138, if the SS evaluation for the test SV list fails (e.g., SS test for fault mode 0 fails), the GNSS device 1102 may begin an iteration to shrink the “test SV list.” The output of the indication may be performed by, e.g., the SS RAIM component 198, the SPS module 1516, the transceiver(s) 1522, the cellular baseband processor(s) 1524, and/or the application processor(s) 1506 of the apparatus 1504 in FIG. 15. In some implementations, to output the indication of: (1) using the position estimated from all SVs in the list of SVs, or (2) removing an SV from the list of SVs for the subsequent SS test, the UE may be configured to transmit the indication of: (1) using the position estimated from all SVs in the list of SVs, or (2) removing an SV from the list of SVs for the subsequent SS test, or store the indication of: (1) using the position estimated from all SVs in the list of SVs, or (2) removing an SV from the list of SVs for the subsequent SS test.

In another example, to estimate the plurality of positions of the UE using all SVs in the list of SVs and the plurality of subsets of SVs in the list of SVs, the UE may be configured to estimate a first position of the UE using all SVs in the list of SVs, and estimate a set of second positions of the UE using the plurality of subsets of SVs in the list of SVs.

In another example, the SS evaluation is associated with SS RAIM.

In another example, to perform the SS evaluation based on the rest of the plurality of positions, the UE may be configured to compare a first validated position in the rest of the plurality of positions with each of a plurality of second validated positions in the rest of the plurality of positions, and enable the SS evaluation to pass if a difference between each comparison does not exceed a difference threshold, or enable the SS evaluation to fail if the difference for at least one comparison exceeds the difference threshold. In some implementations, the first validated position corresponds to a first position of the UE estimated using all SVs in the list of SVs, where the WSS of the first position is less than the chi-square threshold and the computed residual for the first position is a positive value. In some implementations, a second validated position in the plurality of second validated positions corresponds to a second position of the UE estimated using a subset of SVs in the list of SVs, where the WSS of the second position is less than the chi-square threshold and the computed residual for the second position is a positive value.

In another example, to estimate the plurality of positions of the UE using all SVs in the list of SVs and the plurality of subsets of SVs in the list of SVs, the UE may be configured to measure signals from all SVs in the list of SVs, and estimate the plurality of positions of the UE based on the measurements.

In another example, the UE may determine that the WSS for each position in the set of positions is greater than the chi-square threshold, and to exclude the set of positions in the plurality of positions from the SS evaluation, the UE may be configured to exclude the set of positions in the plurality of positions from the SS evaluation based on the determination that each position in the set of positions is greater than the chi-square threshold.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an ultrawide band (UWB) module 1538, an SPS module 1516 (e.g., GNSS module), one or more sensors 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, a camera 1532, and/or an electronic control unit (ECU) 1534. The Bluetooth module 1512, the UWB module 1538, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the SS RAIM component 198 may be configured to estimate a plurality of positions of the UE using all SVs in a list of SVs and a plurality of subsets of SVs in the list of SVs. The SS RAIM component 198 may also be configured to exclude a set of positions in the plurality of positions from an SS evaluation if at least one of: (1) a WSS of the set of positions is greater than a chi-square threshold or (2) a computed residual of the set of positions indicates a negative value. The SS RAIM component 198 may also be configured to perform, after excluding the set of positions in the plurality of positions, the SS evaluation based on rest of the plurality of positions. The SS RAIM component 198 may be within the cellular baseband processor(s) 1524, the application processor(s) 1506, or both the cellular baseband processor(s) 1524 and the application processor(s) 1506. The SS RAIM component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for estimating a plurality of positions of the UE using all SVs in a list of SVs and a plurality of subsets of SVs in the list of SVs. The apparatus 1504 may further include means for excluding a set of positions in the plurality of positions from an SS evaluation if at least one of: (1) a WSS of the set of positions is greater than a chi-square threshold or (2) a computed residual of the set of positions indicates a negative value. The apparatus 1504 may further include means for performing, after excluding the set of positions in the plurality of positions, the SS evaluation based on rest of the plurality of positions.

In one configuration, the apparatus 1504 may further include means for calculating the WSS for each position in the plurality of positions, and means for comparing the calculated WSS for each position in the plurality of positions with the chi-square threshold.

In another configuration, the apparatus 1504 may further include means for computing a residual value for each position in the plurality of positions, and means for determining whether the computed residual value for each position in the plurality of positions is the negative value.

In another configuration, the apparatus 1504 may further include means for outputting, based on the SS evaluation, an indication of: (1) using a position estimated from all SVs in the list of SVs, or (2) removing an SV from the list of SVs for a subsequent SS test. In some implementations, the means for outputting the indication of: (1) using the position estimated from all SVs in the list of SVs, or (2) removing an SV from the list of SVs for the subsequent SS test may include configuring the apparatus 1504 to transmit the indication of: (1) using the position estimated from all SVs in the list of SVs, or (2) removing an SV from the list of SVs for the subsequent SS test, or store the indication of: (1) using the position estimated from all SVs in the list of SVs, or (2) removing an SV from the list of SVs for the subsequent SS test.

In another configuration, the means for estimating the plurality of positions of the UE using all SVs in the list of SVs and the plurality of subsets of SVs in the list of SVs may include configuring the apparatus 1504 to estimate a first position of the UE using all SVs in the list of SVs, and estimate a set of second positions of the UE using the plurality of subsets of SVs in the list of SVs.

In another configuration, the SS evaluation is associated with SS RAIM.

In another configuration, the means for performing the SS evaluation based on the rest of the plurality of positions may include configuring the apparatus 1504 to compare a first validated position in the rest of the plurality of positions with each of a plurality of second validated positions in the rest of the plurality of positions, and enable the SS evaluation to pass if a difference between each comparison does not exceed a difference threshold, or enable the SS evaluation to fail if the difference for at least one comparison exceeds the difference threshold. In some implementations, the first validated position corresponds to a first position of the UE estimated using all SVs in the list of SVs, where the WSS of the first position is less than the chi-square threshold and the computed residual for the first position is a positive value. In some implementations, a second validated position in the plurality of second validated positions corresponds to a second position of the UE estimated using a subset of SVs in the list of SVs, where the WSS of the second position is less than the chi-square threshold and the computed residual for the second position is a positive value.

In another configuration, the means for estimating the plurality of positions of the UE using all SVs in the list of SVs and the plurality of subsets of SVs in the list of SVs may include configuring the apparatus 1504 to measure signals from all SVs in the list of SVs, and estimate the plurality of positions of the UE based on the measurements.

In another configuration, the apparatus 1504 may further include means for determining that the WSS for each position in the set of positions is greater than the chi-square threshold, and the means for excluding the set of positions in the plurality of positions from the SS evaluation may include configuring the apparatus 1504 to exclude the set of positions in the plurality of positions from the SS evaluation based on the determination that each position in the set of positions is greater than the chi-square threshold.

The means may be the SS RAIM component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of positioning at a user equipment (UE), comprising: estimating a plurality of positions of the UE using all space vehicles (SVs) in a list of SVs and a plurality of subsets of SVs in the list of SVs; excluding a set of positions in the plurality of positions from a solution separation (SS) evaluation if at least one of: (1) a weighted sum of squared residual (WSS) of the set of positions is greater than a chi-square threshold or (2) a computed residual of the set of positions indicates a negative value; and performing, after excluding the set of positions in the plurality of positions, the SS evaluation based on rest of the plurality of positions.
Aspect 2 is the method of aspect 1, wherein estimating the plurality of positions of the UE using all SVs in the list of SVs and the plurality of subsets of SVs in the list of SVs comprises: estimating a first position of the UE using all SVs in the list of SVs; and estimating a set of second positions of the UE using the plurality of subsets of SVs in the list of SVs.
Aspect 3 is the method of aspect 1 or aspect 2, further comprising: calculating the WSS for each position in the plurality of positions; and comparing the calculated WSS for each position in the plurality of positions with the chi-square threshold.
Aspect 4 is the method of any of aspects 1 to 3, further comprising: computing a residual value for each position in the plurality of positions; and determining whether the computed residual value for each position in the plurality of positions is the negative value.
Aspect 5 is the method of any of aspects 1 to 4, wherein the SS evaluation is associated with SS-receiver autonomous integrity monitoring (RAIM) (SS RAIM).
Aspect 6 is the method of any of aspects 1 to 5, wherein performing the SS evaluation based on the rest of the plurality of positions comprises: comparing a first validated position in the rest of the plurality of positions with each of a plurality of second validated positions in the rest of the plurality of positions; and enabling the SS evaluation to pass if a difference between each comparison does not exceed a difference threshold, or enabling the SS evaluation to fail if the difference for at least one comparison exceeds the difference threshold.
Aspect 7 is the method of any of aspects 1 to 6, wherein the first validated position corresponds to a first position of the UE estimated using all SVs in the list of SVs, wherein the WSS of the first position is less than the chi-square threshold and the computed residual for the first position is a positive value.
Aspect 8 is the method of any of aspects 1 to 7, wherein a second validated position in the plurality of second validated positions corresponds to a second position of the UE estimated using a subset of SVs in the list of SVs, wherein the WSS of the second position is less than the chi-square threshold and the computed residual for the second position is a positive value.
Aspect 9 is the method of any of aspects 1 to 8, wherein estimating the plurality of positions of the UE using all SVs in the list of SVs and the plurality of subsets of SVs in the list of SVs comprises: measuring signals from all SVs in the list of SVs; and estimating the plurality of positions of the UE based on the measurements.
Aspect 10 is the method of any of aspects 1 to 9, further comprising: determining that the WSS for each position in the set of positions is greater than the chi-square threshold; wherein excluding the set of positions in the plurality of positions from the SS evaluation comprises: excluding the set of positions in the plurality of positions from the SS evaluation based on the determination that each position in the set of positions is greater than the chi-square threshold.
Aspect 11 is the method of any of aspects 1 to 10, further comprising: outputting, based on the SS evaluation, an indication of: (1) using a position estimated from all SVs in the list of SVs, or (2) removing an SV from the list of SVs for a subsequent SS test.
Aspect 12 is the method of any of aspects 1 to 11, wherein outputting the indication of: (1) using the position estimated from all SVs in the list of SVs, or (2) removing an SV from the list of SVs for the subsequent SS test comprises: transmitting the indication of: (1) using the position estimated from all SVs in the list of SVs, or (2) removing an SV from the list of SVs for the subsequent SS test; or storing the indication of: (1) using the position estimated from all SVs in the list of SVs, or (2) removing an SV from the list of SVs for the subsequent SS test.
Aspect 13 is an apparatus for positioning at a user equipment (UE), including: at least one memory; and at least one processor coupled to the at least one memory and, based at least in part on stored information that is stored in the at least one memory, the at least one processor, individually or in any combination, is configured to implement any of aspects 1 to 12.
Aspect 14 is the apparatus of aspect 13, further including at least one transceiver coupled to the at least one processor.
Aspect 15 is an apparatus for positioning at a user equipment (UE) including means for implementing any of aspects 1 to 12.
Aspect 16 is a computer-readable medium (e.g., a non-transitory computer-readable medium) storing computer executable code, where the code when executed by a processor causes the processor to implement any of aspects 1 to 12.

What is claimed is:

1. An apparatus for positioning at a user equipment (UE), comprising:
at least one memory; and
at least one processor coupled to the at least one memory, the at least one processor, individually or in any combination, is configured to:
estimate a plurality of positions of the UE using all space vehicles (SVs) in a list of SVs and a plurality of subsets of SVs in the list of SVs;
exclude a set of positions in the plurality of positions from a solution separation (SS) evaluation if at least one of: (1) a weighted sum of squared residual (WSS) of the set of positions is greater than a chi-square threshold or (2) a computed residual of the set of positions indicates a negative value; and
perform, after excluding the set of positions in the plurality of positions, the SS evaluation based on rest of the plurality of positions.

2. The apparatus of claim 1, wherein to estimate the plurality of positions of the UE using all SVs in the list of SVs and the plurality of subsets of SVs in the list of SVs, the at least one processor, individually or in any combination, is configured to:
estimate a first position of the UE using all SVs in the list of SVs; and
estimate a set of second positions of the UE using the plurality of subsets of SVs in the list of SVs.

3. The apparatus of claim 1, wherein the at least one processor, individually or in any combination, is further configured to:
calculate the WSS for each position in the plurality of positions; and
compare the calculated WSS for each position in the plurality of positions with the chi-square threshold.

4. The apparatus of claim 1, wherein the at least one processor, individually or in any combination, is further configured to:
compute a residual value for each position in the plurality of positions; and
determine whether the computed residual value for each position in the plurality of positions is the negative value.

5. The apparatus of claim 1, wherein the SS evaluation is associated with SS-receiver autonomous integrity monitoring (RAIM) (SS RAIM).

6. The apparatus of claim 1, wherein to perform the SS evaluation based on the rest of the plurality of positions, the at least one processor, individually or in any combination, is configured to:
compare a first validated position in the rest of the plurality of positions with each of a plurality of second validated positions in the rest of the plurality of positions; and
enable the SS evaluation to pass if a difference between each comparison does not exceed a difference threshold, or enable the SS evaluation to fail if the difference for at least one comparison exceeds the difference threshold.

7. The apparatus of claim 6, wherein the first validated position corresponds to a first position of the UE estimated using all SVs in the list of SVs, wherein the WSS of the first position is less than the chi-square threshold and the computed residual for the first position is a positive value.

8. The apparatus of claim 6, wherein a second validated position in the plurality of second validated positions corresponds to a second position of the UE estimated using a subset of SVs in the list of SVs, wherein the WSS of the second position is less than the chi-square threshold and the computed residual for the second position is a positive value.

9. The apparatus of claim 1, wherein to estimate the plurality of positions of the UE using all SVs in the list of SVs and the plurality of subsets of SVs in the list of SVs, the at least one processor, individually or in any combination, is configured to:
measure signals from all SVs in the list of SVs; and
estimate the plurality of positions of the UE based on the measurements.

10. The apparatus of claim 1, wherein the at least one processor, individually or in any combination, is further configured to:
determine that the WSS for each position in the set of positions is greater than the chi-square threshold;
wherein to exclude the set of positions in the plurality of positions from the SS evaluation, the at least one processor, individually or in any combination, is configured to: exclude the set of positions in the plurality of positions from the SS evaluation based on the determination that each position in the set of positions is greater than the chi-square threshold.

11. The apparatus of claim 1, wherein the at least one processor, individually or in any combination, is further configured to:
output, based on the SS evaluation, an indication of: (1) using a position estimated from all SVs in the list of SVs, or (2) removing an SV from the list of SVs for a subsequent SS test.

12. The apparatus of claim 11, wherein to output the indication of: (1) using the position estimated from all SVs in the list of SVs, or (2) removing an SV from the list of SVs for the subsequent SS test, the at least one processor, individually or in any combination, is configured to:
transmit the indication of: (1) using the position estimated from all SVs in the list of SVs, or (2) removing an SV from the list of SVs for the subsequent SS test; or
store the indication of: (1) using the position estimated from all SVs in the list of SVs, or (2) removing an SV from the list of SVs for the subsequent SS test.

13. A method of positioning at a user equipment (UE), comprising:
estimating a plurality of positions of the UE using all space vehicles (SVs) in a list of SVs and a plurality of subsets of SVs in the list of SVs;
excluding a set of positions in the plurality of positions from a solution separation (SS) evaluation if at least one of: (1) a weighted sum of squared residual (WSS) of the set of positions is greater than a chi-square threshold or (2) a computed residual of the set of positions indicates a negative value; and
performing, after excluding the set of positions in the plurality of positions, the SS evaluation based on rest of the plurality of positions.

14. The method of claim 13, wherein estimating the plurality of positions of the UE using all SVs in the list of SVs and the plurality of subsets of SVs in the list of SVs comprises:
estimating a first position of the UE using all SVs in the list of SVs; and
estimating a set of second positions of the UE using the plurality of subsets of SVs in the list of SVs.

15. The method of claim 13, further comprising:
calculating the WSS for each position in the plurality of positions; and
comparing the calculated WSS for each position in the plurality of positions with the chi-square threshold.

16. The method of claim 13, further comprising:
computing a residual value for each position in the plurality of positions; and
determining whether the computed residual value for each position in the plurality of positions is the negative value.

17. The method of claim 13, wherein performing the SS evaluation based on the rest of the plurality of positions comprises:
comparing a first validated position in the rest of the plurality of positions with each of a plurality of second validated positions in the rest of the plurality of positions; and
enabling the SS evaluation to pass if a difference between each comparison does not exceed a difference threshold, or enabling the SS evaluation to fail if the difference for at least one comparison exceeds the difference threshold.

18. The method of claim 13, wherein estimating the plurality of positions of the UE using all SVs in the list of SVs and the plurality of subsets of SVs in the list of SVs comprises:
measuring signals from all SVs in the list of SVs; and
estimating the plurality of positions of the UE based on the measurements.

19. The method of claim 13, further comprising:
outputting, based on the SS evaluation, an indication of: (1) using a position estimated from all SVs in the list of SVs, or (2) removing an SV from the list of SVs for a subsequent SS test.

20. A computer-readable medium storing computer executable code at a user equipment (UE), the code when executed by at least one processor causes the at least one processor to:
estimate a plurality of positions of the UE using all space vehicles (SVs) in a list of SVs and a plurality of subsets of SVs in the list of SVs;
exclude a set of positions in the plurality of positions from a solution separation (SS) evaluation if at least one of: (1) a weighted sum of squared residual (WSS) of the set of positions is greater than a chi-square threshold or (2) a computed residual of the set of positions indicates a negative value; and
perform, after excluding the set of positions in the plurality of positions, the SS evaluation based on rest of the plurality of positions.
